(19) United States
(12) Patent Application Publication
(10) Pub. No.: US 2014/0122324 A1
(43) Pub. Date: May 1, 2014

(54) System and Method for Online Gift and Donation Exchange

(71) Applicant: Laurence Spier, Roslyn, NY (US)

(72) Inventor: Laurence Spier, Roslyn, NY (US)

(21) Appl. No.: 13/662,794

(22) Filed: Oct. 29, 2012

(51) Int. Cl. G06Q 20/10; G06Q 30/00

(52) U.S. Cl. CPC G06Q 20/10; G06Q 30/00
USPC 705/39

(57) ABSTRACT

An online method for facilitating the exchange of monetary or non-monetary gifts comprising, providing a computer data transfer server communicatively linked to a wide area network, connecting a gift exchange server communicatively to the computer data transfer server, giving access to the computer data transfer server to at least one user, registering the at least one user as a gift exchange user, accepting a monetary transfer or gift purchase for a exchangeable gift from the at least one user, storing data in the gift exchange server identifiably linked to the at least one user that is associated with the exchangeable gift; and transferring the exchangeable gift from one user to another user.

### CLAIM OF PRIORITY

This application claims the benefit under to a US Provisional Patent Application filed in the USPTO on Oct. 28, 2011 and assigned Ser. No. 61/552,954, the disclosure of which is hereby incorporated by reference in its entirety.

### FIELD OF THE INVENTION

The present invention relates generally to an online system and method having social media capabilities for assisting in gift and donation exchanges between individuals for traditional gift exchange events such as birthdays, religious holidays and occasions, graduations, weddings, baby showers and other events and for donations and gifts to charitable and political causes. The present invention further enables a gift recipient to register a gift receiving event or occasion whereby gift donor may selectively donate, give or exchange a gift to a particular individual for a preselected occasion or occasions.

### BACKGROUND OF THE INVENTION

Monetary gift giving for persons, charities and political organizations in America is a large and comprehensive part of the modern economy. Some estimates place the overall gifting economy in the trillions of dollars. This economy is primarily based on traditional practices of cash and check exchange. Thus, while many aspects of the modern economy have become modernized, the gift exchange practices remain rooted in old methodologies. Traditionally, gifts have been exchanged between individuals for a variety of occasions from childhood events such as birthdays and religious holidays and occasions to adult events such as weddings and baby showers. The traditional means of gift giving has usually been to purchase an item, give cash or more recently present a gift card of a particular denomination for general use or use at a particular retail establishment. However, the traditional gift giving process has several drawbacks. First, given the availability and ubiquity of internet access in home and business computers as well as mobile devices including electronic shopping portals, it can be both inefficient and inconvenient to shop in brick and mortar stores. This can be especially true when a gift donor has little time to shop or must procure a gift or short notice. In addition, the traditional gift giving process typically is reliant on the donor selecting a gift that is desired by and useful to the gift recipient. In the event that the gift recipient does not want the selected gift, then they must return or exchange the gift. In either case, the gift recipient is burdened with the additional tasks of going to a store to complete the gift giving/receiving process. Moreover, if the gift recipient does not return or exchange the undesired gift, then they may be left with an unwanted gift and over time accumulate a large number of unwanted gifts that go unused and are thus wasted.

A further drawback of the traditional gift giving process is that sometimes gifts are given by purchasing a gift card for use at a particular store, shop or restaurant. These gift cards may be lost, go unused or be for a store, shop or restaurant that the gift recipient does not need to, or want to patronize. In either case, the gift is once again wasted. Therefore, the gains in shopping efficiency when conducted online are still coupled with the same exchange problems of conventional gift selection and giving. In an online situation, the recipient still must receive the gift and physically return it when they are not satisfied with the gift. In other words, a gift exchange still requires the recipient to get the gift and physically return it if not satisfied, resulting in continued inefficiencies and waste.

Additionally, today many people utilize many online social media tools for enabling and managing many aspects of their interactions with family, friends, colleagues, business and political associates and other personal and commercial interactions.

Accordingly, there is a need for a system that allows for the efficient selection by a gift recipient and the acceptance and exchange of a gift that does not require the recipient to receive an undesired gift and physically exchange the gift and more particularly to provide for a system that provides an efficient means to eliminate the waste of unwanted gifts in the gift giving process and instead implement a system whereby it is easy and desirable to provide a gift recipient with a gift of real value and long term benefit. Moreover, there is a need for executing such a system in an online environment using desktop computers, laptops and portable devices such as tablets and smart phones wherein a users can establish an easily accessible social media site for the exchange of information regarding personal gifts and charity, business and political causes to enable the online exchange gifts.

### SUMMARY OF THE INVENTION

Methods, systems and articles of manufacture consistent with the present invention overcome the shortcomings of existing systems by permitting efficient online gift registration, acceptance and customized exchanging of an online gift. Consistent with the present system, gifts may be exchanged between a conferrer and a recipient using the online system. In one embodiment, the recipient may register with the system of the present invention in order to designate a particular gift or list of gifts to receive. Alternately, the recipient may receive gifts without registering as a gift recipient with the system according to the present invention. In that way the use of the online gift exchange system of the present invention may be initiated by either the gift donor or the recipient without the need for preregistration by either party. Thus the method of the present invention provides both efficiency in use as well as maintains the ability of the gift donor to surprise a recipient with a gift.

Accordingly it is an object of the invention to provide a system and method for providing an online gift exchange, donation and receipt system, wherein both donors and recipients may utilize an online system to give and receive gifts without the need for pre-registration.

It is a further object of the present invention to provide a system and method for providing an online gift exchange, donation and receipt system, wherein the donor may provide a gift to a recipient in the form of an donation or contribution into an investment or savings vehicle that is linked to an institutional account such as a regular or college savings account that the recipient may use to build equity for long or short term projects

It is a further object of the present invention to provide a system and method for providing an online system whereby a donor can efficiently arrange to have a gift and notification delivered to an recipient without the need for the donor to visit any physical location to purchase a gift and notification.

The above objects and features of the present invention are accomplished, as embodied and fully described herein, by an online method for facilitating the exchange of monetary or non-monetary gifts comprising, providing a computer data transfer server communicatively linked to a wide area network, connecting a gift exchange server communicatively to the computer data transfer server, giving access to the computer data transfer server to at least one user, registering the at least one user as a gift exchange user, accepting a monetary transfer or gift purchase for a exchangeable gift from the at least one user, storing data in the gift exchange server identifiably linked to the at least one user that is associated with the exchangeable gift; and transferring the exchangeable gift from one user to another user.

With those and other objects, advantages and features of the invention that may become hereinafter apparent, other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings in which:

FIG. 1 shows a block diagram of components of a system for online system and method for assisting in gift and donation exchanges in accordance with one embodiment of the present invention.

FIG. 2, there is shown an exemplary flow chart for an exemplary embodiment of the present invention.

FIG. 3 shows a flowchart for one aspect of an exemplary embodiment of the present invention.

FIG. 4 shows a flowchart for one aspect of an exemplary embodiment of the present invention.

FIG. 5 shows a flowchart for one aspect of an exemplary embodiment of the present invention.

FIG. 6 shows a block diagram for a web page in accordance with an exemplary embodiment of the present invention.

FIG. 7 shows a block diagram for a web page in accordance with an exemplary embodiment of the present invention.

FIG. 8 shows a block diagram for a web page in accordance with an exemplary embodiment of the present invention.

### DETAILED DESCRIPTION OF THE PREFERRED EMBODIMENT

Several preferred embodiments of the invention are described for illustrative purposes, it being understood that the invention may be embodied in other forms not specifically shown in the drawings.

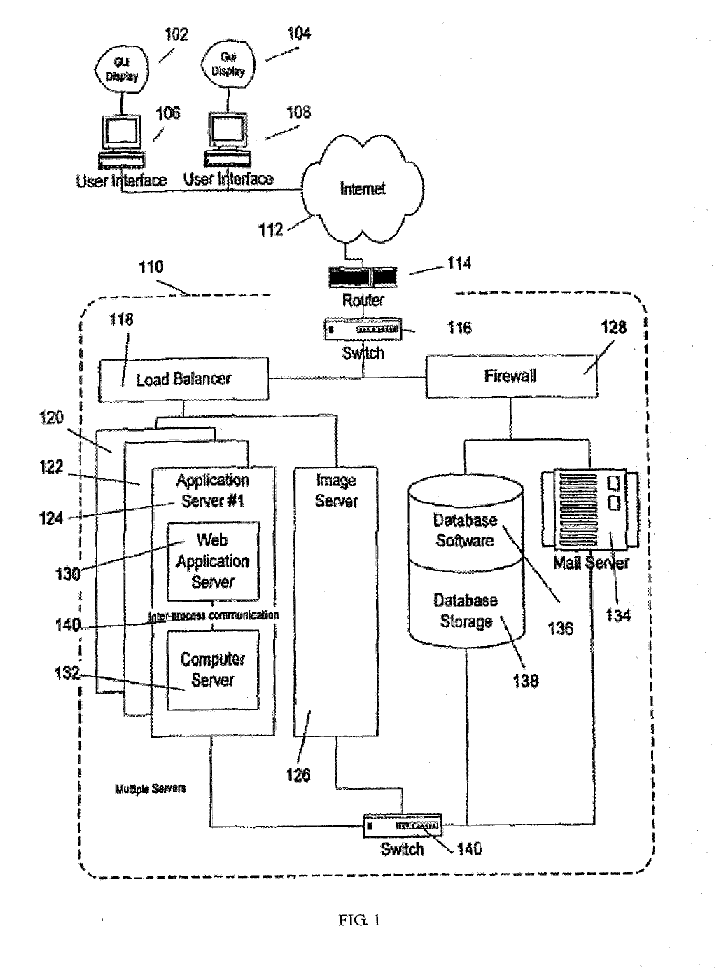

A schematic of the general system architecture of an online system and method for assisting in gift and donation exchanges according to one aspect of the present invention may be described in accordance with the block diagram of FIG. 1. FIG. 1 illustrates the general architecture of a system that operates in accordance with one embodiment of the present invention. As shown in FIG. 1, a plurality of graphical user interface (GUI) displays 102 & 104 are presented on a plurality of user interface devices 106 & 108 connected to an apparatus 110 via the Internet 112. The user interface may be any device capable of presenting data, including, but not limited to, cellular telephones, smart phones, computers, tablet computers, television sets or hand-held devices such as a “personal digital assistants.” As used herein, the term “Internet” generally refers to any collection of distinct networks working together to appear as a single network to a user. The term refers to the so-called world wide “network of networks” that are connected to each other using the Internet protocol (IP) and other similar protocols. The Internet provides file transfer, remote log in, electronic mail, news and other services. As described herein, the exemplary public network of FIG. 1 is for descriptive purposes only. Although the description may refer to terms commonly used in describing particular public networks such as the Internet, the description and concepts equally apply to other public and private computer networks, including systems having architectures dissimilar to that shown in FIG. 1. For example, and without limitation thereto, the system of the present invention can find application in public as well as private networks, such as a closed university social system, or the private network of a company.

The apparatus 110 is connected to the Internet 112 through a router 114 and a switch 116. As is well known in the relevant art(s), routers forward packets between networks. The router 114 forwards information packets between the apparatus 110 and devices 106 & 108 over the Internet 112. A load balancer 118 balances the traffic load across multiple mirrored servers 120, 122, 124 and a firewall 128 provides protection from unauthorized access to the apparatus 110. The switch 116 may act as a gatekeeper to and from the Internet 112. The components appearing in the apparatus 110 refer to an exemplary combination of those components that would need to be assembled to create the infrastructure in order to provide the tools and services contemplated by the present invention. As will be apparent to one skilled in the relevant art(s), all of components “inside” of the apparatus 110 may be connected and may communicate via a wide or local area network (WAN or LAN).

The apparatus 110 includes an application server 124 or a plurality of application servers 124. The application server 124 comprises a web application server 130 and a computer server 132 that serves as the application layer of the present invention. Yet another server is the image server 126, which has the purpose of storing and providing digital images to other components of the apparatus 110. Also included is a mail server 134, which sends and receives electronic messages to and from devices 106 & 108. Also included are the database software 136 and a database 138.

The Web application server 130 is a system that sends out Web pages in response to Hypertext Transfer Protocol (HTTP) requests from remote browsers (i.e. users of the apparatus 110). That is, the Web server 130 provides the GUI 102 & 104 to users of the system in the form of Web pages. These Web pages sent to the user's device 106 & 108 would result in GUI screens 102 & 104 being displayed.

The apparatus 110 also includes a second switch 140 that allows the components of the apparatus to be interconnected in a local area network (LAN) or a wide area network (WAN). Thus, data can be transferred to and from the various components of the apparatus 110.

As will be appreciated by those skilled in the relevant art(s), this configuration of router 114 and switch 116 is flexible and can be omitted in certain embodiments. Additional routers 114 and/or switches 116 can also be added.

The application server 124, the database(s) 136, 138 and the mail server 134 are shielded from the public Internet 112 through the firewall 128. The firewall 128 is a dedicated gateway machine with special security precaution software. It is typically used, for example, to service Internet 112 connections and dial-in lines and protects the cluster of more loosely administered network elements hidden behind it from external invasion. Firewalls are well known in the relevant art(s).

As will be appreciated by those skilled in the relevant art(s), the inclusion of the firewall 128 is flexible and can be omitted in certain embodiments. Additional firewalls 128 can also be added.

The computer server 132 may include a central processing unit (CPU), a random access memory (RAM) temporary storage of information, and a read only memory (ROM) for permanent storage of information. Computer server 132 may be generally controlled and coordinated by an operating system software. The operating system controls allocation of system resources and performs tasks such as processing, scheduling, memory management, networking and I/O services, among things. Thus, the operating system resident in system memory and executed by CPU coordinates the operation of the other elements of the apparatus 110.

Although the description of the computer server 132 may refer to terms commonly used in describing particular computer servers, the description and concepts equally apply to other processing systems, including systems having architectures dissimilar to that shown in FIG. 1.

Also included is an inter-process communications protocol 140 (IPCP), a set of rules for marshalling and un-marshalling parameters and results. This is the activity that takes place at the point where the control path in the calling and called process enters or leaves the IPCP domain. The IPCP is essentially a set of rules for encoding and decoding information transmitted between multiple processes.

As will be appreciated by those skilled in the relevant art(s), the inclusion of the IPCP 140 is flexible and can be substituted or omitted in certain embodiments.

The apparatus 110 may also include the image server 126 or a plurality of image servers that manage(s) digital photographs and other human viewable images. The image server 126 may be configured separately from the web server 130. This configuration may increase the scalability of the server apparatus 110. Alternatively, the web server 130 and the image server 126 can be configured together. Examples of image formats that can be managed by the image server 126 include, but are not limited to, Graphical Interchange Format (“GIF”), Joint Photographics Experts Group (“JPEG”), or Portable Network Graphics (“PNG”) or Tagged Image File (“TIF”).

The mail server 134 is a repository for e-mail messages received from the Internet 112. It also manages the transmission of electronic messages (“electronic mail” or “e-mail”). The mail server 134 consists of a storage area, a set of user definable rules, a list of users and a series of communication modules. Its primary purpose in the present invention is the storage and distribution of e-mail messages to the Internet 112.

The databases 136, 138 store software, descriptive data, digital images, system data and any other data item required by the other components of the apparatus. The databases may be provided, for example, as a database management system (DBMS), and object-oriented database management system (ODBMS), a relational database management system (e.g. DB2, ACCESS etc.), a file system or another conventional database package. Thus, the databases 136 & 138 can be implemented using object-oriented technology or via text files. Further, the databases 136 & 138 can be accessed via a Structured Query Language (SQL) or other tools known to one of ordinary skill in the art.

Given the descriptions of the preferred and alternative embodiments of the present invention, it will be readily appreciated that the invention is not limited to any particular monetary denomination or world currency.

The invention contemplates that the gift exchange recipient may receive a monetary gift from a donor. The monetary gift in the preferred embodiment of the present invention may typically take the form of a monetary deposit into a account established for the recipient. The account may take the form of either a pre-established account set up by the recipient, or may be established by action of the gift donor. In this way, the donor may use the system and method of the present invention whether or not the recipient has previously established a recipient account, thus providing and maintaining the surprise element for a donor making a gift. In other words, the recipient need not be consulted or set up an account in advance of gift donor's using the system and method of the present invention to give a gift.

In one embodiment, the system and method according to the present invention contemplates that a gift recipient or donor may access the gift server of the present invention via a network connection such as the Internet. Once the gift donor or donor has accessed the gift server portal they will be prompted to either access the recipient account, or to establish a donor account that is then accepted by the recipient at a later time. The procedure therefore of the present invention makes it possible for the recipient to be surprised by a gift. There is no need under the present invention to establish a recipient account in advance. In the case of the non-registered recipient, the donor, upon accessing the gift server is prompted to provide both donor and recipient details. A web page of the gift server that a donor may access may typically include fields for the donor to enter personal information about themselves as well as personal information identifying the recipient. The donor and recipient information is stored in a secure database. In addition, the donor provides information regarding the gift that is to be given. In accordance with the preferred embodiment of this invention, the gift is typically a monetary gift that is deposited into an account for the recipient, alternately; a check may be mailed to the recipient along with a card or other gift item, for example flowers. The recipient may also receive an electronic notification of the gift or if the donor desires, a card or other notice may be selected for physically mailing the recipient. In this way, the entire gift giving experience can be concluded online without the need to stop at a store or other physical location to purchase a gift or card.

The gift server and database are configured to accept information from the donor regarding the gift in order to arrange for a transfer to the recipient. This can be accomplished via a secure (https) connection that is configured between the gift server and the donor whereby the donor can purchase a gift credit for the recipient. The gift credit may typically be purchased using a credit card. The gift purchase may be made by way of any well-known payment processing company. The gift server may be linked via the Internet to the payment processing company. The funds deposited by the gift donor may then be held by the gift processing company for distribution to the recipient. The gift processing company will in accordance with the present invention, maintain a record of the gifts for each recipient and the identity of the donor. In this way the recipient will receive the correct distribution of gifts and the donor of each gift will be properly recorded and acknowledged.

In a further embodiment of the present invention, the gift processing company may collect a fee from each donor for providing the service of processing of the gift exchange. The fee can vary in accordance with the amount of the gift or other parameters. Moreover, the fee need not be charged, but can be waived.

The system and method according to the present invention may be implemented in such a way that the recipient establishes an account with the gift exchange processing company. In this way the recipient is registered with the gift exchange processor and recipients may log onto a pre-established account. In this embodiment, the present invention contemplates that the gift exchange recipient will submit information to the gift server for creating an online gift exchange processing company account which may include information about the recipient and the gift receipt occasion for which the recipient is registering. The recipient user may submit information using a personal computer or hand held computing device such as a smart phone or tablet computer in data communication over a communications network with a web server in the gift server system. Alternatively, or in conjunction with providing the information electronically, the gift exchange processing company registrant may provide the information telephonic ally, through written submission, or some other means. The user profile information may be saved in a database.

The gift exchange processing company registrant may customize the online gift exchange processing account either at the time of establishing the registry, or at any later time. One of the customization features available to the gift exchange processing company registrant is the option to include in the registry a list of pre-selected gift suggestions with links to those items from selected third party retailers, a monetary gift, gift cards, a deposit or donation to an investment account which may be pre-established with a bank or other investment brokerage or even a bill pay option. The customized details of the gift exchange processing company may be saved in the same database as the user profile, or in a separate registry database. In establishing the gift registry, the operator may also register with several online merchants such as Amazon, Ebay, and others to obtain an affiliate ID. Moreover, the gift exchange processing company operator may also obtain an affiliate ID from marketing companies such as Linkshare or Clickbank or advertising networks such as Google Ad-sense. In this way the operator of the gift exchange processing company system according to the present invention can generate revenue though serving relevant ads to the users or more particularly by generating revenue through affiliate referrals. As in the present embodiment of the invention, the gift exchange processing company user establishes an affiliate ID account with anyone of a plurality of merchants and may also establish an account with an advertising network such as for example Google Ad-sense.

In an embodiment of the present invention, a gift recipient registers an account with the gift exchange processing company operator. During the registration process in addition to personal information the recipient may indicate certain gifts that they desire to receive. After the recipient registers with the gift exchange processing company operator, a donor may then log onto the gift exchange processing company site and access the recipient account. Access to the recipient account may be controlled by password. Once a donor accesses the recipient account, they may then be presented with a plurality of gift giving options. Those options may include anyone of the options listed above, such as a selected gift item, a monetary gift, gift card, or investment donation.

In any of the gift giving options selected, the gift exchange processing company operator would preferably have established an advertising and affiliate relationship with the third-party provider's. In that way, if the recipient had preselected a certain gift item or class of items, for example cameras, the donor would see advertisements for cameras presented on the web page associated with the recipients account. Moreover, the links for the items displayed would include the affiliate ID for the gift exchange processing company operator. In that way, when the donor selects a link to purchase an item, the purchaser is referred to the merchant site via the gift exchange processing company operator affiliate ID and thereby generating revenue for the gift exchange processing company operator. Additionally, the items posted may be presented to the donor based on the preselected items that the recipient has indicated they would be interested in as gifts. In this way, the advertising network such as Google Adsense or any other such advertising network may serve appropriate advertisements to the donor.

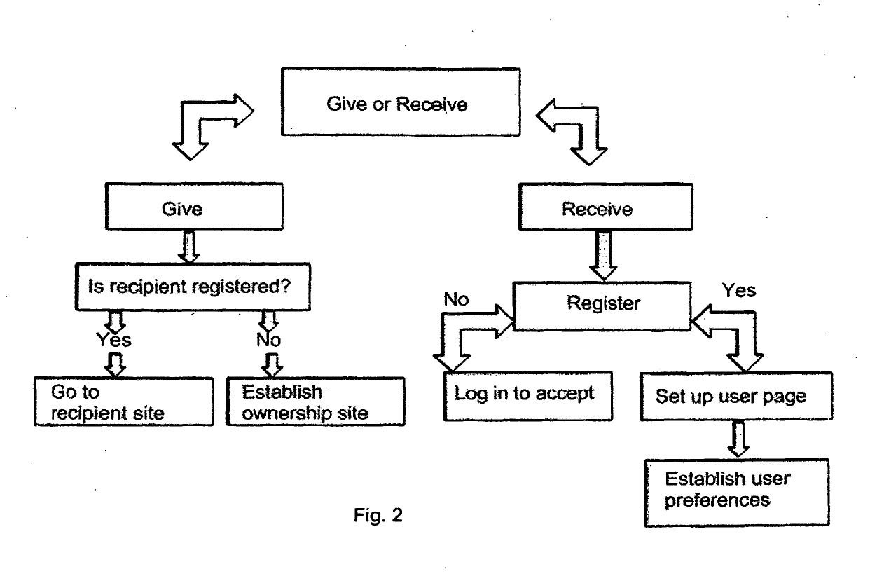

Turning now to FIG. 2, there is shown an exemplary flow chart for an exemplary embodiment of the present invention. In the exemplary embodiment, a user would access the gift exchange processing company web site. The user would first choose the options for giving or receiving a gift or contribution. For a user accessing a giving option, they would then select the option for either a registered or non-registered recipient. For a registered recipient, the giver or donor would proceed to the recipient's site. This can be accomplished by any well-known methods in the art including searching for the recipient or using pull down menus or the like to find the recipient's name. Once at the recipient site, the donor will be able to access options for providing the gift as will be explained further hereinafter. In the alternative, for an un-registered recipient, the user may establish a web-page or site for gifting funds or other gifts to that particular recipient. In that way a user or group of users that want to surprise a recipient with a gift can do so even when that recipient has not pre-registered. Once the donor or donors have established a site for that particular recipient, they will establish accounts with the providers that are listed for the receipt of gifts and subsequent transfer to the donor. They will also then be provided with log in credentials that can be transmitted to the recipient. In that way the recipient can then claim the gifts at a later time. As will be further explained, the gifts can be provided through a variety of means such as a gift account with a merchant, a “cash” account set up with a financial institution, or any variety of money exchange methods, such as Pay Pal™ or the like.

Of course, as it is well known in the art, once a donor or recipient site is established, that donor or recipient, or other members of the public would be able to directly navigate to the site in order to access the options available for that user.

Turning again to FIG. 2, if the user that is a recipient of gifts or contributions, the user may establish an online account identity profile, similar to a user of Facebook™. In that way the user can establish an online account as will be further explained that provides information about the gift or cause as well as giving options for donors. The giving options would include for example the establishment of accounts with banks or other such entities for the receipt of funds in the recipient's name. These can include bank accounts, investment accounts, merchant accounts and other savings, or monetary transfer vehicles that may be available. Other options may include for example that the donor may select the option to send a check or other cash transfer directly to the recipient. This can be done by accessing option that will be provided for the donor to perform an electronic funds transfer, or forwarding a payment to the gift exchange processing company, which will then have a check drawn on a account and paid to the recipient. Of course other methods of payment are contemplated including sending physical gift, which may be selected from an associated merchant, sending a gift card, an electronic funds transfer or other such payment. Alternately for a recipient user that is not registered and does not want to do so, but is merely accepting a gift or donation made to them, they can log in with the log-in credentials that are provided to them by the donors. Once logged in, they can then be directed to claim their gifts or donations such as from a Pay Pal™ or similar site.

In accordance with the present invention, the user may establish the a user account using typical methods known in the art. For example, the registrant, either donor or recipient would be presented with screen images for the input of personal identifying information. This may include but not limited to, name, address, email address, an account username and password, a password hint, and other personal information. The gift exchange recipient will also agree, in this example, to the website's terms of use agreement. The gift recipient is presented with clickable buttons to electronically submit his personal information to the server or cancel the sign up process. As will be readily understood by one skilled in the art of secure online communications, for extra security, the recipient may also be all of the above listed information will take place via a secure sockets layer (SSL) connection, moreover the recipient may also utilize a two-factor (TF) encryption method.

By submitting the registrants information, the web server systems according to the present invention will store to a user profile record in database which will be accessible and retrieval over the network/internet.

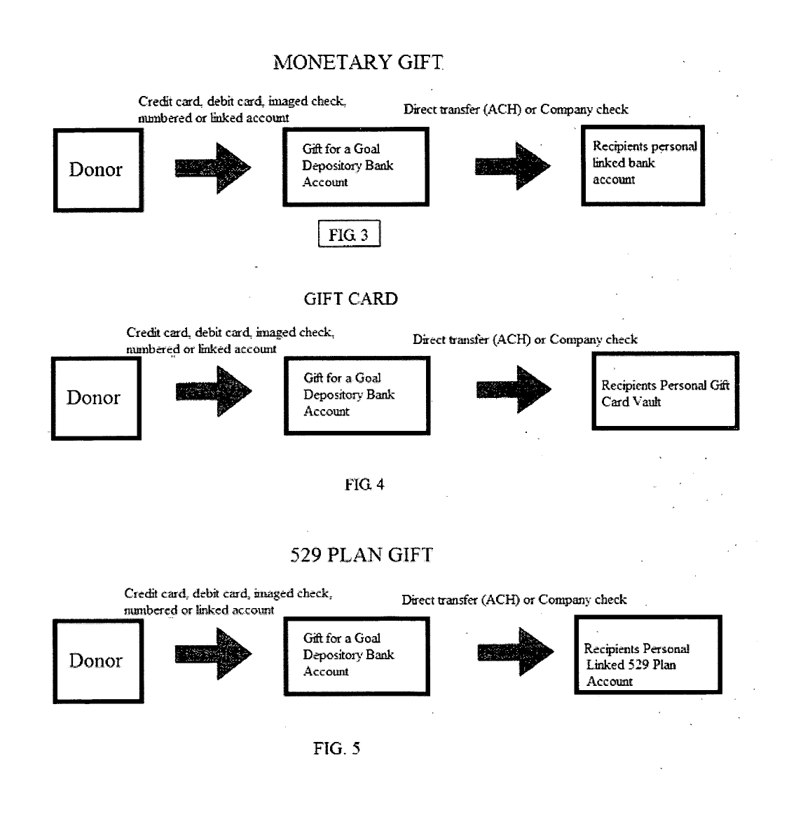

Turning now to FIG. 3, there is provided a block diagram flow chart for a particular embodiment of the present invention wherein a donor gives a monetary gift. In this embodiment the donor, after accessing the site as explained above, can provide a monetary gift using a credit card, debit card, imaged check or back account electronic funds transfer authorization. The donation or gift would then be transferred to an account that has been established by the donor or recipient as explained above, where the recipient can claim the gift or donation.

Turning now to FIG. 4, there is provided a block diagram flow chart for a particular embodiment of the present invention wherein a donor gives a monetary gift. In this embodiment the donor, after accessing the site as explained above, can provide a monetary gift using a credit card, debit card, imaged check or back account electronic funds transfer authorization. The donation or gift would then be transferred to an account that has been established by the donor or recipient as explained above. In this case, the donor or recipient can pre=select that the gift be delivered in the form of a gift card, which gift exchange processing company can facilitate with any number of associated providers. Also, either the donor or recipient may select that gifted funds be aggregated onto one card for example in order to minimize the number of gift cards and ease of record keeping, or they could pre-select that gift cards from multiple merchants in order that they can purchase goods or services from a number or providers.

Turning now to FIG. 5, there is provided a block diagram flow chart for a particular embodiment of the present invention wherein a donor gives a gift of a contribution to a college “529” savings account. Of course one skilled in the are will recognize that the account established for the recipient need not be only a “529” account, but other investment and savings accounts are also contemplated within this invention. In this embodiment the donor, after accessing the site as explained above, can provide a monetary gift using a credit card, debit card, imaged check or back account electronic funds transfer authorization. The donation or gift would then be transferred to an account that has been established by the donor or recipient as explained above, where the recipient can claim the gift or donation.

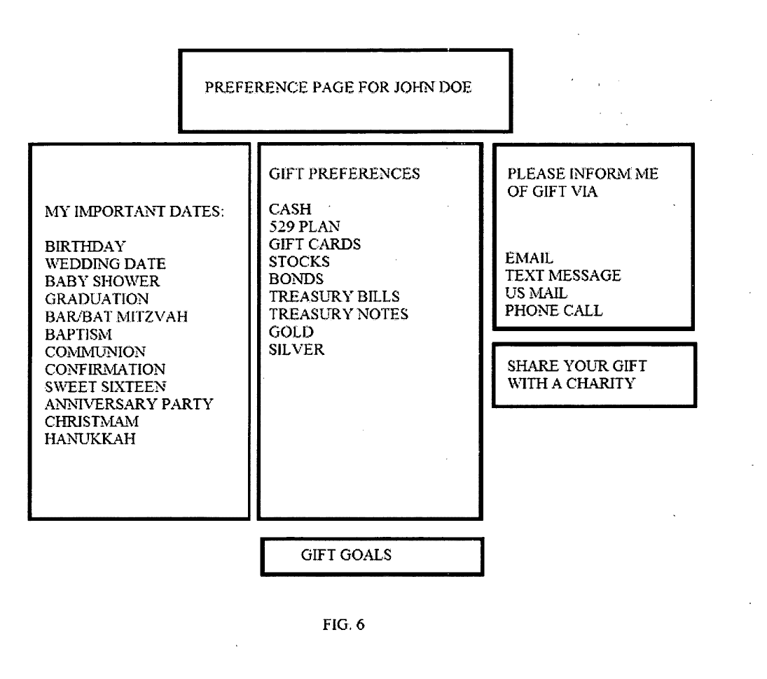

Turning now to FIG. 6 there is shown an exemplary web site depiction or page for a recipient. Such a page is exemplary of a page that could be established by either the donor or the recipient. In this way a donor could for example establish a page to solicit donations for a person or cause or a recipient could do the same. In addition, the page could be established for a particular event such as a wedding, anniversary, baby shower or college graduation. In this way, the present invention could be used for both situations where a recipient is aware of the gift donations or is not aware, i.e. a surprise gift. Turning to FIG. 6 there is shown a exemplary Preference page for the recipient. This page is only exemplary and the layout and preferences are not meant to be limiting. Other similar options are contemplated within the scope of the invention.

Turning again to FIG. 6., there is shown a plurality of fields that may be established. The fields may include the name of the recipient, such as a persons name or political or charitable cause. The fields may also include important dates as shown for a person, such as birthday, wedding, shower, graduation, anniversary dates, such as wedding anniversary or other occasions. In the case of a political or charitable cause, there could be included benchmark dates or other fund raising goal dates. Other options could include listing for example, different individual matters that the funds are being raised to support. For example, if the charitable cause is raising money for a children's illness, the individual matters could include different research institutions receiving money.

In addition, the fields may include a gift preference list, which as explained above may include options. for cash, investments, gift cards, stock, bonds or physical gifts such as gold and silver or even gifts from merchants such as book, apparel, electronics and commodities, although this list is not limiting and any type of consumer product may be contemplated herein.

Options may also be provided for notification to the recipient such as an email notification, text message, a card sent via standard mail or overnight delivery services or even a phone call. The notification may be selected from a standard list of notices or may be personalized by the user. Additionally for example donors may be able to post a message related to the gift on the recipient site similar to message capabilities on other social media sites. Other options include for example a twitter post or “tweet” that may be sent out when a donation is made. This can be especially utilized in connection with political or charitable donations. In that case the user can post a message in support of the cause that is then “tweeted” or distributed via other social media outlets.

The preference page can be used exclusively by the user setting up the page or may be viewable to any prospective donor. In that way the user establishing the page may select what preferences are seen by the donors, or may tailor any preferences to the particular recipient.

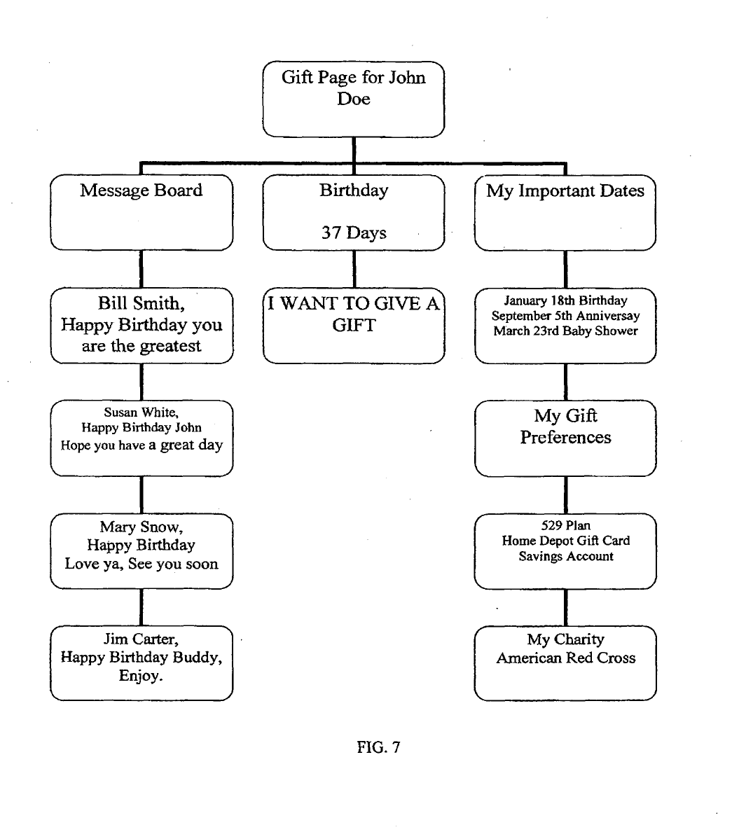

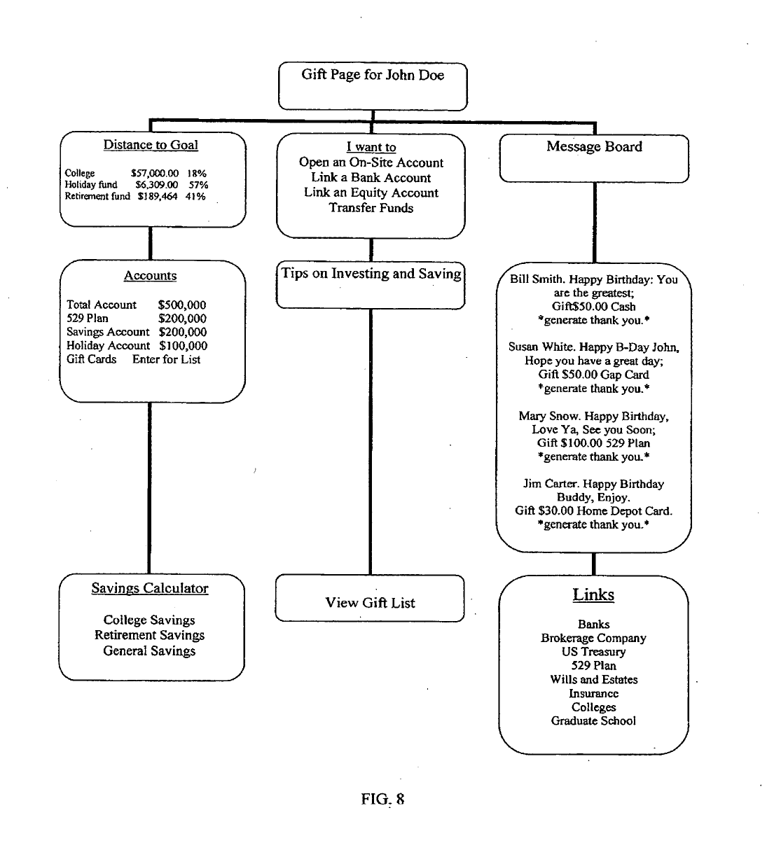

Turning now to FIG. 7, there is shown an exemplary public page that may be established for a particular recipient. The public page may be similar to a social media page wherein the user may in response to input on a set-up page establish fields that are viewable by the donors that access the site. These fields may include a message board, which as explained with respect to FIG. 6, may include the ability for donors or the recipient to post messages. As explained above, these messages may be linked to other social media outlets for dissemination such as Facebook™, Twitter™, Instagram™, SMS or MMS messaging or other similar services. E-cards or cards sent through the mail are also contemplated. The public page may also include for example, important dates for the recipient, gift preferences, such as investment accounts, gift cards, savings, or monetary gift choices.

The recipient when establishing their site would complete a registration process to link their gift preference accounts with their public page. This would include a process to arrange for deposits into accounts such as Pay Pal, electronic funds transfer or other such money payment methods known in the art. These links would be established using secure connections established by the providers. For example, a user may establish a link to a 529 investment account to allow for deposits into that account. The donors would be provided routing information and then be prompted to access a secure site for setting up an electronic funds transfer to that account. Alternately, for example the donor could be directed to a credit card payment site for the payment of funds to an account.

Turning now to FIG. 8, there is shown an exemplary private page that may be established for a user such as a recipient for tracking information related to the recipient fund raising or gifts. The private page may be shielded from public view by way of a password-protected login, encryption or other means. The user may also elect to provide public view to any of the private fields. For example the recipient user may provide access to the Distance to Goal field. In that way donors can be informed of the amount of money raised for a cause. For example, if a community is raising funds for a school project, the field can let the donors and prospective donors know the amount raised so far as well as the amount need to reach their goal. The Fields that may be provided, include but are not limited to: Distance to Goal, as explained above, Accounts, which would provide a list and link via secure connections to the users gift or fund raising accounts, a message board as previously explained, online tools such as savings calculators, links to organizations and service providers, educational sites, tools for customizing their recipient site, for example tools to open or link accounts and tools for the user to make transfer of funds from donor accounts to their personal account.

The tools may include links to online calculators for college or retirement savings, general savings for user personal goals such as home improvement projects and the like. In this way the site according to the present invention need not be used exclusively as a donor and recipient site, but a user can establish a site for their own exclusive use to track progress towards a savings goal. For example, for college savings or savings for a necessity or luxury purchase. In that way, while the user may establish the site to meet their own personal goals, they can subsequently adapt their use of the site to solicit or accept donations from other parties in the event of an occasion or other change in circumstance, such as a college graduation, wedding or other event.

Tools may also include links to educational sites such as tips on investing and savings. The user may select from a pre-set menu of sites, or may customize this field with sites that the user selects themselves, or are recommended to the user by donors or other visitors to the site. The Links field may also be populated in a similar fashion.

The gift exchange according to the present invention may as described above include the option for cash gifts, gift cards or other physical gifts. These options would be provided through the gift exchange processing company servers and would be effectuated by the user through clicking on links provided to the donor. For example, the gift exchange processing company may provide links to affiliate merchant sites for which affiliate partner agreements, as is known in the art, have been established. In that way for example, a donor could be directed to a merchant site for giving a particular gift. For example, an affiliate agreement could be established with Amazon to allow a donor to shop for any gift from a pre-selected list of desired gifts, such as a physical consumer good item, re-loadable debit card account, or even a gift card that the recipient has selected or simply send a gift of the donor's choosing. Similarly with respect to a cash gift, the donor could be linked and directed to a third party site for the transfer of cash to the donor such as Pay Pal or similar sites, or as establish links with a recipient bank account for an electronic funds transfer. Another alternate may provide for links to pay certain bills on behalf of the recipient. Credit card transaction may be accomplished according to typical and customary credit card transaction procedures. In this case the donors credit or debit card account may be debited an amount that corresponds to the gift that is made or the cost of the item that is purchased.

In addition, affiliate partner agreements that are established by the registrant user can provide to the gift exchange processing company referral fees as set forth in pre determined agreements. In that way, when a user of the gift exchange processing company uses a partner service, revenue can be generated for the gift exchange processing company.

Furthermore, the recipient may have a customized page with a list of suggested gifts, or in the case of a charity, a list of suggested donation amounts. The list of suggested gifts may be linked to third party retailer sites and have an affiliate ID attached to the link in order to generate revenue for the gift exchange site operator. Also, in accordance with the present invention, more that one monetary gift receipt account may be established or linked through the gift exchange website. In addition, the recipient may choose to have more than one gift option available for the donor to select.

As another option, the users may elect to see or exclude advertisements for related or suggested products. In this way, the registrant can customize their page as well as take advantage of suggestions that can be provided to them regarding gift ideas.

As set forth above, a donor will be able to access the public page of a recipient in much the same way as a user accesses a friend or families Facebook™ page. In this way, the donor can as explained above, learn of the recipient's gift preferences as well as communicate with the recipient and other donors. The servers of the gift exchange company will use standard methods known in the art maintains databases which save in a secure manner all the information regarding both donors and recipients. This information can be secured and access controlled using standard log-in techniques known in the art. This could for example include encryption with digital certificates and two-factor authentication.

It is contemplated in accordance with this invention that any method of online monetary transfer may be used including third party providers, credit cards, electronic check scanning and the like. As set forth above, both recipients and donors may establish accounts. In this way, one for example that make frequent contribution to charitable causes can establish an account with the online gift exchange company according to the present invention for the transfer of funds to the charity, or even set up a recurring donation. For example, if a donor desires to make a monthly donation to a local community group, they could establish an account in accordance with the present invention and set a recurring donation to the community group. The user could also using the messaging function, provide reminders to themselves via a text message for example that the monthly donation is being made, and even solicit further donations for the cause from friends, family and other interested individuals.

In this case, where a donor establishes a donor site in accordance with the present invention, they could link their already existing accounts to their site, or they could set up a specific account with the gift exchange processing company partner provider such as a bank, or a deposit account that is held by the gift exchange processing company. This account could be replenished using typical means and donations and gifts could be made from this account. In this way the user could move funds from their own accounts to a gift exchange processing company accounts and recipient accounts using the secure transaction site provided by the present invention.

One of ordinary skill in the art will appreciate that there are myriad ways in which a gift donor can interface with the system using one or more forms that is generally described as follows. Although certain presently preferred embodiments of the disclosed invention have been specifically described herein, it will be apparent to those skilled in the art to which the invention pertains that variations and modifications of the various embodiments shown and described herein may be made without departing from the spirit and scope of the invention. Accordingly, it is intended that the invention be limited only to the extent required by the appended claims and the applicable rules of law.

1. An online method for facilitating the exchange of monetary or non-monetary gifts comprising:
a. Providing a computer data transfer server communicatively linked to a wide area network,
b. Connecting a gift exchange server communicatively to said computer data transfer server,
c. transferring data for establishing a gift account of at least one gift recipient and at least one gift donor,
d. Registering said gift accounts of both of said at least one gift recipient and at least one gift donor in a database on said gift exchange server,
e. linking a third-party monetary account or non-monetary account to said gift account of said at least one gift recipient and said at least one gift donor,
f. enabling the exchange of a gift from said third-party monetary or non-monetary account to said gift account of at least one gift recipient,
g. completing the exchange of a gift from said third-party monetary or non-monetary account to said gift account of at least one gift recipient, and
h. Storing data in said gift exchange server identifying said gift from said third-party monetary or non-monetary account with said gift account of at least one gift recipient and said at least one gift donor.
